(19) United States
(12) Patent Application Publication
(10) Pub. No.: US 2013/0011688 A1
(43) Pub. Date: Jan. 10, 2013

(54) Corrosion Resistant Metal Coating and Method of Making Same

(76) Inventor: Michael Lee Beaver, Phoenix, AZ (US)

(21) Appl. No.: 13/249,151

(22) Filed: Sep. 29, 2011

Related U.S. Application Data
(60) Provisional application No. 61/530,371, filed on Sep. 1, 2011.
(60) Provisional application No. 61/505,880, filed on Jul. 8, 2011.

(51) Int. Cl. B32B 15/04; B05D 1/00; B05D 3/00; C25D 11/18; C25D 11/04

(52) U.S. Cl. 428/469; 205/324; 205/325; 205/50; 427/444; 427/327; 427/398.1; 427/180

(57) ABSTRACT

A method to treat a surface of an oxide coated metal substrate. The method comprises providing a metal substrate having an oxide layer, sealing said oxide layer, and cooling said metal substrate to a temperature of −300° F. or less.

### CROSS-REFERENCE TO RELATED APPLICATIONS

This application claims priority to, and the benefit of, U.S. Provisional Application Ser. No. 61/505,880, filed on Jul. 8, 2011, titled “Triplex—Aluminum Oxide Thermal Variable Process,” and to U.S. Provisional Application Ser. No. 61/530,371, filed on Sep. 1, 2011, titled “Corrosion Resistance Metal Coating And Method Of Making Same,” both of which are incorporated herein by reference.

### TECHNICAL FIELD

The disclosure relates in general to a corrosion resistant, wear resistant and electrically insulative surface formed on the surface of certain metals, and more particularly to a process for forming and treating an anodic coating, and most particularly to a process for forming an anodic coating, sealing the anodic coating, and cryogenically processing the anodic coating and underlying substrate.

### BACKGROUND ART

Anodic coatings are commonly applied to the surface of metal articles to provide corrosion and wear resistance. Anodizing processes use electrolysis to promote the growth of a relatively thick oxide layer on the surface of the metal article. Metals most commonly anodized are aluminum, magnesium, steel, iron, zinc, and titanium. The oxide layer is formed by the reaction of surface metal with oxygen to form a metal oxide.

The oxide layer formed by prior art anodic coatings is brittle. When bending, shaping, or otherwise distorting a coated article, the more ductile underlying substrate will bend, but the coating will fracture and crack and severely decrease the coating's corrosion resistance. Prior art anodizing processes are therefore limited to the last step in the manufacturing process because the coated article must be in its final form. Similarly, any impact or other force that distorts an anodized article during use will likely cause cracking of the oxide layer and provide an avenue for corrosion.

Prior art oxide layers are also susceptible to cracking and peeling from thermal stress as a result of differences in the crystalline structure of the substrate and the oxide layer. Prior art anodic coatings are also susceptible to corrosion when exposed to strong acidic solutions because the acid reacts with and dissolves the aluminum oxide. Over time, cracking, flaking, and pealing of the anodic coating results, exposing the underlying substrate. Anodized articles prepared with prior art anodization techniques, therefore, are not suitable for such acidic environments or must be frequently monitored and replaced.

Accordingly, it would be an advance in the state of the art to provide a metal coating that (i) is highly resistant to both corrosion and wear, (ii) retains its corrosion and wear resistance after the surface has been bent, impacted, or otherwise deformed, (iii) is highly resistant to acidic environments, and/or (iv) remains substantially intact after being exposed to thermal stress.

### SUMMARY OF THE INVENTION

Applicant's disclosure relates to a method to treat a surface of a metal substrate. The method comprises providing a metal substrate having an oxide layer, treating said oxide layer, and cooling said metal substrate to a temperature of −300° F. or less. Applicant's disclosure also relates to a method to treat a surface of a metal substrate. The method comprises providing a metal substrate including a surface, forming a non-oxide coating on the surface, cooling the metal substrate to a temperature of −300° F. or less. Applicant's disclosure also relates to a metallic article of manufacture, formed by the process of providing a metal substrate having an oxide layer, treating said oxide layer, and cooling said metal substrate to a temperature of −300° F. or less.

### BRIEF DESCRIPTION OF THE DRAWINGS

The invention will be more fully understood by referring to the following Detailed Description of Specific Embodiments in conjunction with the Drawings, of which:

FIG. 1 is a flowchart of an exemplary method for forming an anodic coating on a metal article;

FIG. 2 is a flowchart of an exemplary method for sealing the anodic coating formed in FIG. 1;

FIG. 3; is a flowchart of an exemplary method for forming a non-anodic coating on a metal article; and

FIG. 4 is a flowchart of an exemplary method for cryogenically processing a metal article having an anodic or a non-anodic coating.

### DETAILED DESCRIPTION OF SPECIFIC EMBODIMENTS

This invention is described in preferred embodiments in the following description with reference to the Figures, in which like numerals represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the above description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

In one embodiment, an anodic coating for metal articles and a process for forming same is presented. The process involves first forming an oxide layer on the metal article. The oxide layer is then treated by one or more chemical processes in succession. Finally, the coated article is exposed to a cryogenic processing step. The resultant coating is highly resistant to corrosion, is highly resistant to chemical exposure, including exposure to strong acidic environments, is extremely resistant to abrasion, and maintains is protective properties after bent, impacted, or otherwise deformed.

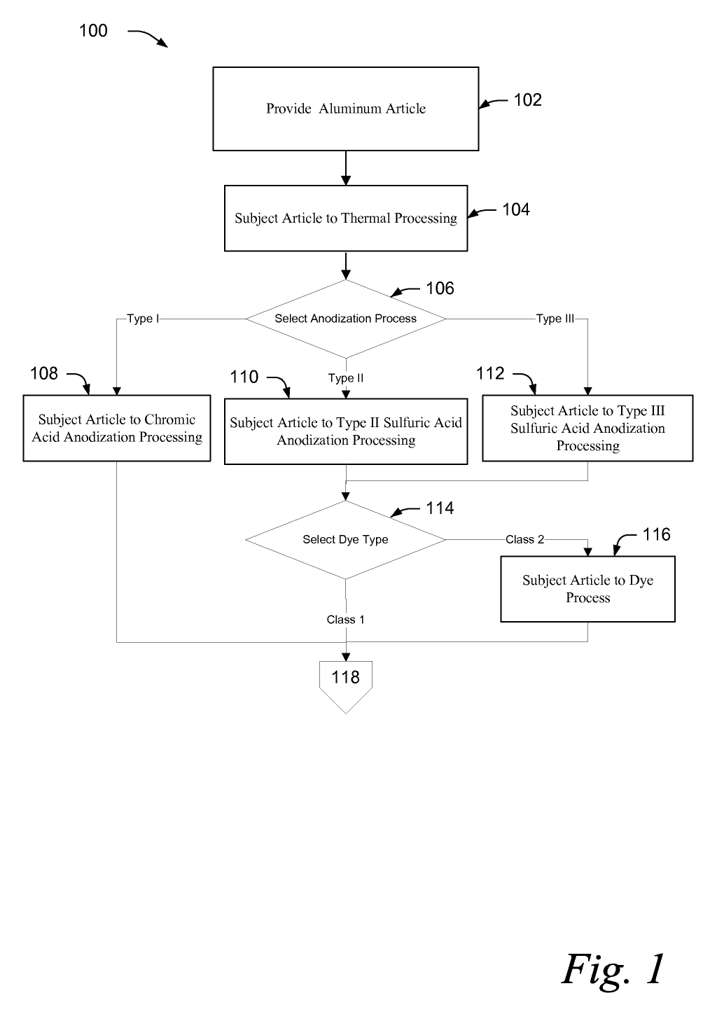

FIG. 1 summarizes Applicant's method 100 for forming an anodic layer on an aluminum alloy substrate. In one embodiment, an aluminum article is provided at step 102. In various embodiments, the article is formed from a 1000 series aluminum comprising pure aluminum, 2000 series wrought aluminum alloy comprising aluminum and copper, 3000 series wrought aluminum alloy comprising aluminum and manganese, 4000 series wrought aluminum alloy comprising aluminum and silicon, 5000 series wrought aluminum alloy comprising aluminum and magnesium, 6000 series wrought aluminum alloy comprising aluminum, magnesium, and silicon, 7000 series wrought aluminum alloy comprising aluminum and zinc, or 8000 series wrought aluminum alloy comprising aluminum and lithium. In one embodiment, the aluminum article is formed from 6061 wrought aluminum alloy. In one embodiment, the aluminum article is formed from 2024 wrought aluminum alloy. In various embodiments, the article is formed from a 200 series cast aluminum alloy comprising aluminum and copper, 300 series cast aluminum alloy comprising aluminum and silicon, copper, and/or magnesium, 400 series cast aluminum alloy comprising aluminum and silicon, or 500 series cast aluminum alloy comprising aluminum and magnesium. In other embodiments, the article is formed from magnesium, steel, copper, iron, titanium, or an alloy thereof.

In one embodiment, the article is subjected to thermal processing at step 104. In various embodiments, the thermal treatment is one of a standard designation type T1 (heated to an elevated temperature and cooled), T2 (annealed), T3 (solution heat treated and subsequently cold worked), T4 (solution heat treated and not cold worked), T5 (cooled from an elevated temperature shaping process), T6 (solution heat treated and artificially aged), T7 (solution heat treated and stabilized), T8 (solution heat treated, stabilized, and artificially aged), T73 (solution heat treated and specially artificially aged), T9 (solution heat treated, artificially aged, and cold worked), or T10 (cooled from an elevated temperature shaping process).

The anodization process is determined at step 106. If the method selects a Type I anodization process, the method transitions to step 108. Type I anodization involves growing an anodic layer on the article in an electrolysis process using a bath of chromic acid solution as the electrolyte. In certain embodiments, step 108 is compliant with Military Specification MIL-A-8625. Type I chromic acid processing results in an anodic layer of between about 0.5 μm to about 18 μm in thickness. The Type I chromic acid electrolytic processing is formed at step 108. The method transitions to step 118.

If the method selects a Type II anodization process, the method transitions to step 110. Type II anodization involves growing an anodic layer on the article via an electrolysis process using an electrolyte bath comprising sulfuric acid or by any conventional Type II anodizing process. In certain embodiments, step 110 is compliant with Military Specification MIL-A-8625. Type II sulfuric acid processing results in an anodic layer of between about 5 μm to about 25 μm in thickness. The Type II sulfuric acid electrolytic processing is formed at step 110. In one embodiment, the temperature of the electrolyte bath for Type II processing is between about 68° F. and about 72° F. In various embodiments, the electrolyte bath used in step 110 comprises phosphoric acid, chromic acid, sulfuric acid, citric acid, oxalic acid, boric acid, or a combination thereof. The method transitions to step 114.

If the method selects a Type III anodization process, the method transitions to step 112. Type III anodization, as designated by Military Specification MIL-A-8625. Type III anodization involves growing an anodic layer on the article via an electrolysis process using a bath comprising sulfuric acid or by any conventional Type III anodizing process. Type III sulfuric acid processing results in an anodic layer of between about 20 μm to about 56 μm in thickness. The process for Type III anodization requires a different process then Type II to achieve the thicker anodic oxide layer. In general, Type III processes use a bath of a lower temperature and use higher voltages than the Type II processes. The Type III sulfuric acid electrolytic processing is formed at step 112. In one embodiment, the temperature of the sulfuric acid solution for Type III processing is between about 30° F. and about 42° F. In various embodiments, the electrolyte bath used in step 112 comprises phosphoric acid, chromic acid, sulfuric acid, citric acid, oxalic acid, boric acid, or a combination thereof. The method transitions to step 114.

A dye or pigmentation type is selected at step 114. If the method selects a Class 1 anodized article, the method transitions to step 118. A Class 1 anodization layer, as designated by Military Specification MIL-A-8625, does not include a dye. As such, no dye is added and the method transitions to step 118.

If the method selects a Class 2 anodized article, the method transitions to step 116. A Class 2 anodization layer, as designated by Military Specification MIL-A-8625, includes a dye. Any standard anodization dye and process may be used. The anodic layer is dyed at step 116. The method transitions to step 118.

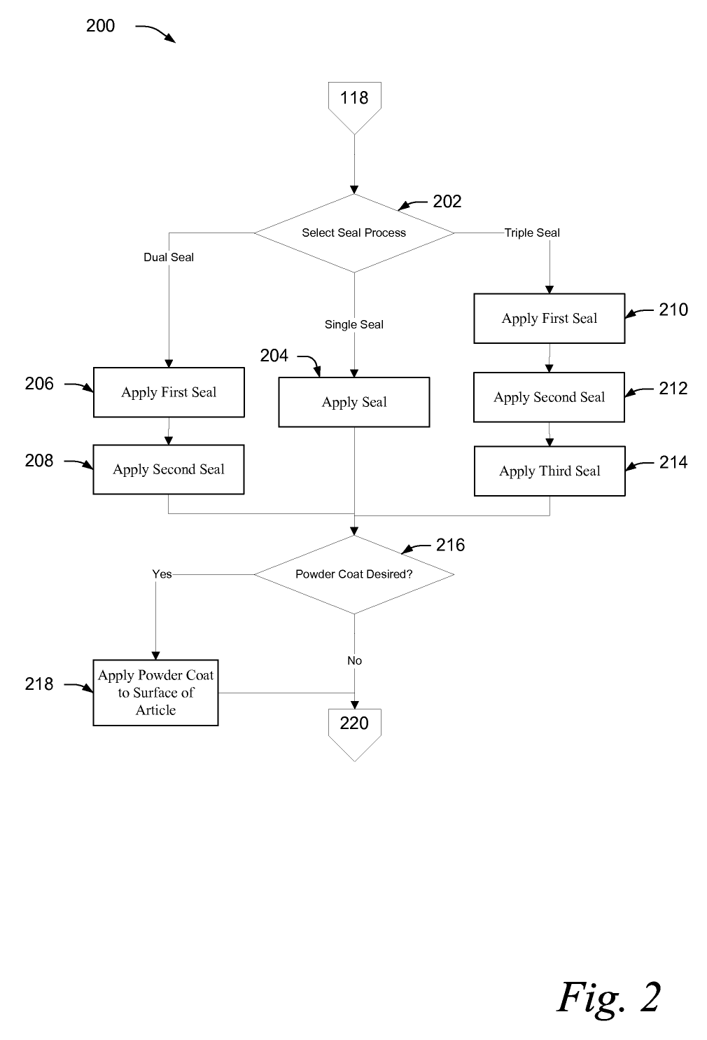

FIG. 2 summarizes one embodiment of Applicant's method 200 for sealing an oxide layer on a metal substrate. In one embodiment, the oxide layer is formed on the article according to the method 100 in FIG. 1 and resumes from step 118. In other embodiments, the oxide layer is formed by a process different from that recited in FIG. 1.

The method selects a seal process at step 202. If the method selects a single seal, the method transitions to step 204. The oxide layer is sealed with a single sealing process at step 204.

In one embodiment, a sodium dichromate seal is used as the single seal in step 204. The sodium dichromate process comprises immersing the article in an aqueous solution containing sodium dichromate to form a modified oxide layer. In one embodiment, the temperature of the sodium dichromate solution is between about 194° F. and about 212° F. In one embodiment, the temperature of the sodium dichromate solution is between about 180° F. and 200° F. In one embodiment, the duration of the sodium dichromate sealing process is about 15 minutes. In one embodiment, the sodium dichromate solution comprises about a 5 weight percent to about a 7 weight percent solution of sodium dichromate in water.

In one embodiment, a nickel seal process is used as the single seal in step 204. The nickel sealing process comprises immersing the article in an aqueous solution containing nickel acetate to form a modified oxide layer. In one embodiment, the temperature of the nickel acetate solution is between about 180° F. and about 195° F. In one embodiment, the temperature of the nickel acetate solution is between about 180° F. and 190° F. In one embodiment, the duration of the nickel acetate sealing process is between about 10 minutes and about 2 hours. In one embodiment, the duration of the nickel acetate sealing process is about 15 minutes. In one embodiment, the duration of the nickel acetate sealing process is about 1 hour. In one embodiment, the nickel acetate solution comprises about a 5 weight percent to about a 10 weight percent solution of nickel acetate in water.

In one embodiment, a hot water seal used as the single seal in step 204. The hot water seal process comprises immersing the article in deionized water heated to between about 190° F. and about 212° F. to form a modified oxide layer. In one embodiment, the deionized water is heated to about 200° F. In one embodiment, the deionized water is heated to greater than 200° F. In one embodiment, the duration of the hot water sealing process is between about 10 minutes to about 20 minutes. In one embodiment, the deionized water has less than 200 parts per million (PPM) of total dissolved solids (TDS). In one embodiment, the deionized water has less than 20 parts per million (PPM) of total dissolved solids (TDS). In one embodiment, the deionized water has less than 10 parts per million (PPM) of total dissolved solids (TDS). The method transitions to step 216.

If the method selects a dual seal, the method transitions to step 206. The oxide layer is treated with a first sealing process at step 206 and a second sealing process at step 208. In one embodiment, step 206 comprises a nickel acetate sealing process and step 208 comprises either a hot water seal or a sodium dichromate seal. In one embodiment, step 206 comprises a sodium dichromate sealing process and step 208 comprises either a hot water sealing process or a nickel acetate sealing process. In one embodiment, step 206 comprises a hot water sealing process and step 208 comprises either a nickel acetate sealing process or a sodium dichromate sealing process.

In one embodiment, step 206 comprises a nickel acetate sealing process and step 208 comprises a sodium dichromate sealing process. In another embodiment, step 206 comprises a sodium dichromate sealing process and step 208 comprises a nickel acetate sealing process. The method transitions to step 216.

If the method selects a triple seal, the method transitions to step 210. The oxide layer is sealed with a first sealing process at step 210, a second sealing process at step 212, and a third sealing process at step 214.

In certain embodiments, Applicant's triple seal must be applied using a specific sequence of treatments. In these embodiments, step 210 comprises a nickel acetate sealing process, step 212 comprises a sodium dichromate sealing process, and step 214 comprises a hot water sealing process.

In other embodiments, step 210 comprises a sodium dichromate sealing process. In other embodiment, step 210 comprises a hot water sealing process.

The method transitions to step 216, wherein the method determines whether a non-oxide coat will be added over the oxide layer at step 216. If the method determines that a non-oxide coat should be added, the method transitions to step 218. A non-oxide coat is applied at step 218. In one embodiment, the non-oxide coat is a powder coat applied by any standard coating process. In one embodiment, the article is heated to 450° F. to set the powder coat. If the method determines that no powder coat should be added, the method transitions to step 220.

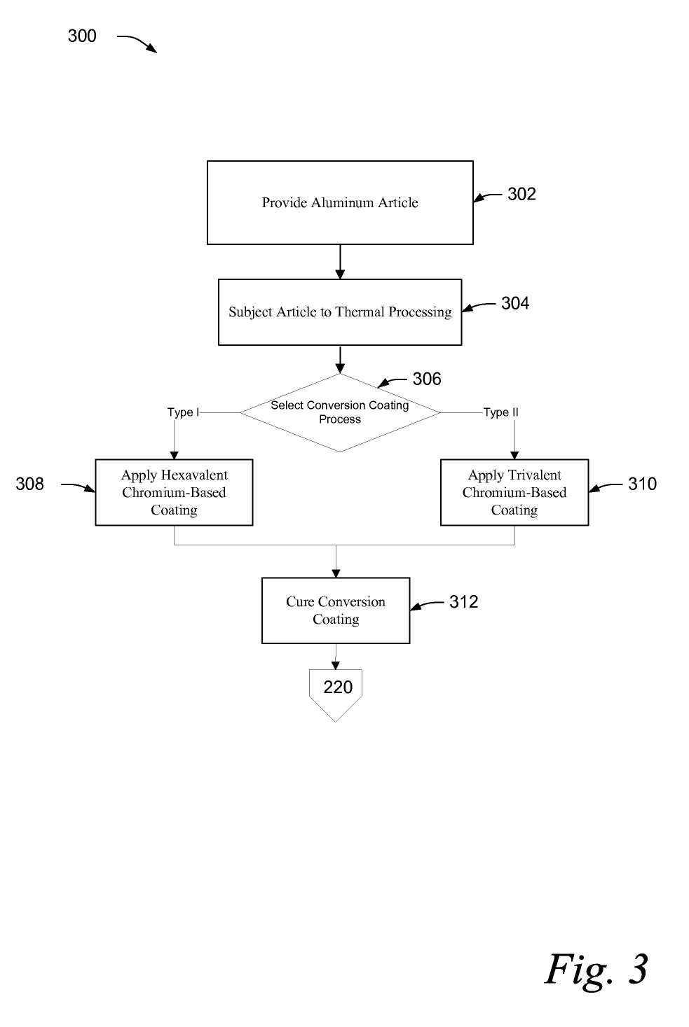

FIG. 3 summarizes the steps of Applicant's method 300 for sealing a non-anodized aluminum article with a chemical conversion coating is depicted. In one embodiment, a metal article is provided at step 302. In various embodiments, the article is formed from a 1000 series aluminum comprising pure aluminum, 2000 series wrought aluminum alloy comprising aluminum and copper, 3000 series wrought aluminum alloy comprising aluminum and manganese, 4000 series wrought aluminum alloy comprising aluminum and silicon, 5000 series wrought aluminum alloy comprising aluminum and magnesium, 6000 series wrought aluminum alloy comprising aluminum, magnesium, and silicon, 7000 series wrought aluminum alloy comprising aluminum and zinc, or 8000 series wrought aluminum alloy comprising aluminum and lithium. In one embodiment, the aluminum article is formed from 6061 wrought aluminum alloy. In one embodiment, the aluminum article is formed from 2024 wrought aluminum alloy. In various embodiments, the article is formed from a 200 series cast aluminum alloy comprising aluminum and copper, 300 series cast aluminum alloy comprising aluminum and silicon, copper, and/or magnesium, 400 series cast aluminum alloy comprising aluminum and silicon, or 500 series cast aluminum alloy comprising aluminum and magnesium. In other embodiments, the article is formed from magnesium, steel, copper, iron, titanium, or an alloy thereof.

In one embodiment, the article is subjected to thermal processing at step 304. In various embodiments, the thermal treatment is one of a standard designation type T1 (heated to an elevated temperature and cooled), T2 (annealed), T3 (solution heat treated and subsequently cold worked), T4 (solution heat treated and not cold worked), T5 (cooled from an elevated temperature shaping process), T6 (solution heat treated and artificially aged), T7 (solution heat treated and stabilized), T8 (solution heat treated, stabilized, and artificially aged), T73 (solution heat treated and specially artificially aged), T9 (solution heat treated, artificially aged, and cold worked), or T10 (cooled from an elevated temperature shaping process).

In one embodiment, in place of steps 302 and 304, the article is process by the method presented in FIG. 1 and sealed by the method presented in FIG. 2 before transitioning to step 306.

The method selects a chemical conversion coating at step 306. If the method selects a Type I conversion coating, the method transitions to step 308. Type I conversion coatings, as designated by Military Specification MIL-DTL-5541, involve immersing the article in a solution comprising hexavalent chromium. The Type I hexavalent chromium-based coating is applied to the article at step 308.

In one embodiment, if a Class 1A coating (as defined by MIL-DTL-5541) is desired, the dwell time of the article in the hexavalent chromium solution is between about 3 minutes to about 5 minutes. In one embodiment, the dwell time is about 3.5 minutes. In one embodiment, if a Class 3 coating (as defined by MIL-DTL-5541) is desired, the dwell time of the article in the hexavalent chromium solution is between about 2 to about 3 minutes. In one embodiment, the dwell time is about 2.5 minutes. The method transitions to step 312.

If the method selects a Type II conversion coating, the method transitions to step 310. Type II conversion coatings, as designated by Military Specification MIL-DTL-5541, do not include hexavalent chromium, which is a toxic material. In one embodiment, Type II conversion coatings include immersing the article in a solution comprising trivalent chromium. The Type II coating is applied to the article at step 310. In one embodiment, if a Class 1A coating (as defined by MIL-DTL-5541) is desired, the dwell time of the article in the hexavalent chromium solution is between about 3 minutes to about 5 minutes. In one embodiment, the dwell time is about 3.5 minutes. In one embodiment, if a Class 3 coating (as defined by MIL-DTL-5541) is desired, the dwell time of the article in the hexavalent chromium solution is between about 2 to about 3 minutes. In one embodiment, the dwell time is about 2.5 minutes. The method transitions to step 312.

The conversion coating is cured at step 312. In one embodiment, the conversion coating is cured by exposing the coating to ambient temperatures for about 24 hours. The method transitions to step 220.

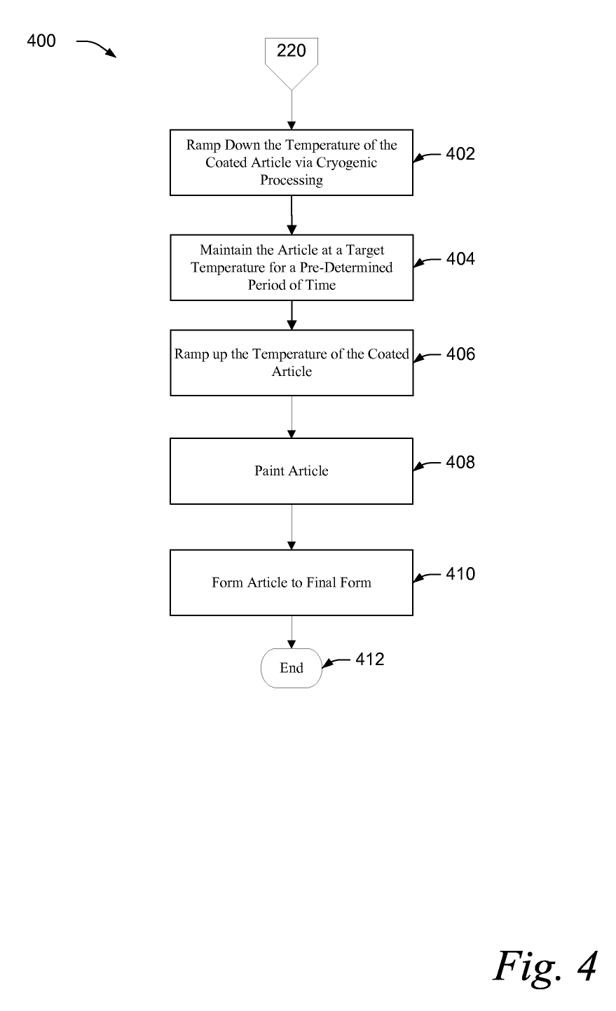

FIG. 4 summarizes the steps of Applicant's method 400 for cryogenically treating an anodized or non-anodized aluminum article is depicted. In one embodiment, the article is an anodized article formed by method 200 in FIG. 2. In one embodiment, the article is a non-anodized article formed by method 300 in FIG. 3. In various embodiments, the article is formed from a 1000 series aluminum comprising pure aluminum, 2000 series wrought aluminum alloy comprising aluminum and copper, 3000 series wrought aluminum alloy comprising aluminum and manganese, 4000 series wrought aluminum alloy comprising aluminum and silicon, 5000 series wrought aluminum alloy comprising aluminum and magnesium, 6000 series wrought aluminum alloy comprising aluminum, magnesium, and silicon, 7000 series wrought aluminum alloy comprising aluminum and zinc, or 8000 series wrought aluminum alloy comprising aluminum and lithium. In one embodiment, the aluminum article is formed from 6061 wrought aluminum alloy. In one embodiment, the aluminum article is formed from 2024 wrought aluminum alloy. In various embodiments, the article is formed from a 200 series cast aluminum alloy comprising aluminum and copper, 300 series cast aluminum alloy comprising aluminum and silicon, copper, and/or magnesium, 400 series cast aluminum alloy comprising aluminum and silicon, or 500 series cast aluminum alloy comprising aluminum and magnesium. In other embodiments, the article is formed from magnesium, steel, iron, titanium, or an alloy thereof.

The article is immersed in a cryogenic fluid and the temperature of the fluid is decreased at step 402. In one embodiment, the cooling rate of the cryogenic fluid is controlled such that the temperature decreases at a linear or substantially linear rate. In one embodiment, the temperature of the cryogenic fluid is gradually reduced from ambient temperature to a target temperature over a period of between about 4 hours and about 10 hours. In one embodiment, the temperature of the cryogenic fluid is gradually reduced from ambient temperature to a target temperature over a period of about 6 hours. In one embodiment, the temperature of the cryogenic fluid is reduced to the target temperature at a rate of between about 20° F. and about 70° F. per hour. In one embodiment, the temperature of the cryogenic fluid is reduced to the target temperature at a rate of about 50° F. per hour.

In one embodiment, the target temperature is between about −180° F. and about −425° F. In one embodiment, the target temperature is about −320° F. In one embodiment, the target temperature is about −380° F. In one embodiment, the target temperature is about −400° F. In one embodiment, the target temperature is below −400° F.

The temperature of the cryogenic fluid is maintained at or near the target temperature at step 404. In one embodiment, the temperature of the cryogenic fluid is maintained at or near the target temperature for a period of between about 10 hours and about 12 hours. In one embodiment, the temperature of the cryogenic fluid is maintained at or near the target temperature for a period of between about 12 hours and about 24 hours. In one embodiment, the temperature of the cryogenic fluid is maintained at or near the target temperature for a period of between about 1 hour and about 10 hours. In one embodiment, the temperature of the cryogenic fluid is maintained between +/−10° F. of the target temperature.

The temperature of the cryogenic fluid is increased at step 406. In one embodiment, the rate of temperature increase of the cryogenic fluid is controlled such that the temperature increases at a linear or substantially linear rate. In one embodiment, the temperature of the cryogenic fluid is gradually increased from the target temperature to ambient temperature over a period of between about 4 hours and about 10 hours. In one embodiment, the temperature of the cryogenic fluid is increased from the target temperature to ambient temperature over a period of about 6 hours. In one embodiment, the temperature of the cryogenic fluid is increased from the target temperature to ambient temperature at a rate of between about 20° F. and about 70° F. per hour. In one embodiment, the temperature of the cryogenic fluid is increased from the target temperature to ambient temperature at a rate of about 50° F. per hour.

In one embodiment, the article is optionally painted at step 408. In one embodiment, the article is further shaped or processed to its final form at step 410. The method ends at step 412.

Test Results of Aluminum Samples Treated with Applicant's Coating Process

Samples of aluminum alloys were treated with different embodiments of Applicant's coating process. The samples were tested for corrosion resistance, impact resistance, abrasion resistance, anodic coating integrity when exposed to high temperatures, and the ability of the coating to withstand bending. All testing was conducted by Durkee Testing Laboratories, Inc. of Paramount, Calif.

Corrosion resistance was tested by exposing the samples to salt spray in conformance with Military Specification MIL-A-8625 and ATSM-B-117-09. The dimensions for each sample were 3 inches by 10 inches with a thickness of about 0.032 inches. The samples were rinsed with D.I. water before being place in a test chamber. A 5% salt solution with a pH of about 6.7 to 6.9 is vaporized to form a fog. The fog is caused to continuously flow over the samples during the testing process. The samples were positioned 6° from the vertical and parallel to the primary direction of flow of fog through the chamber. The air pressure of the testing chamber was maintained at a pressure of about 14 to 14.5 PSI and a temperature of about 34.9° C. to 35.6° C. The surface of the sample is then inspected for signs of corrosion.

Impact resistance was tested by driving a rounded striking rod into a test panel at increasing forces. The dimensions for each sample were 3 inches by 10 inches with a thickness of about 0.032 inches. The initial impact force was set to between 40 and 80 pounds and incremented by 10 pounds for each successive test. The impact site is inspected for signs of substrate exposure due to anodic layer cracking or delamination.

Abrasion resistance was tested by mounting the sample to a turntable and rotating the sample at a fixed speed under weighted CS-17 abrasion wheels. The dimensions for each sample were 4 inches by 4 inches with a thickness of about 0.063 inches. The samples were conditioned at 23° C. and 50% humidity. Testing was conducted at 30° C. and 29% humidity. A vacuum nozzle was positioned at 0.25 inches from each sample to remove any debris. The abrasion wheel was resurface every 500 cycles with an S11 disk. The abrasion wheels were each loaded with 1000 grams. The surface of the sample was inspected for signs of breakthrough (i.e., portions were the anodic layer has been completely removed, exposing the underlaying substrate) and the sample was weighted before and after testing to measure the amount of material loss due to the abrasion.

The ability to withstand flexing was tested by bending a sample at 45°, 135°, or 180° and exposing the sample to a salt spray test as describe above. The dimensions for each sample were 3 inches by 10 inches with a thickness of about 0.032 inches. The portion of the sample over the bend was observed for signs of pitting or corrosion.

The integrity of the anodic coating after exposure to high temperatures was tested by heating samples for two hours at various temperatures. The surface of the samples were inspected after each test by a scanning electron microscope (SEM) and a microphotograph.

The following examples are presented to further illustrate to persons skilled in the art how to make and use the invention. These examples are not intended as a limitation, however, upon the scope of the invention.

Test Sample #1—6061 Aluminum, Type II, Class 1 Anodic Layer

Samples of 6061 aluminum were anodized to form a Type II, Class 1 anodic coating. The samples were first cleaned in an alkaline soap bath at about 150° F. for about five minutes. The samples were then rinsed using water at ambient temperature. The samples were then deoxidized in an acidic solution at a temperature of about 75° F. for about five minutes. The samples were then again rinsed using water at ambient temperature. The samples were then etched in a solution at about 110° F. for about 15 minutes. In one embodiment, the etching solution is a caustic solution of sodium hydroxide formed by mixing 120 lbs of sodium hydroxide in 300 gallons of water. The samples were then again rinsed using water at ambient temperature. The samples were then deoxidized in an acidic solution at a temperature of about 75° F. for about five minutes. The samples were then again rinsed using water at ambient temperature.

The samples were then immersed in an anodizing bath comprising sulfuric acid at about 65° F. An anodization layer was deposited on the sample using a process voltage of about 14 volts for about 30 minutes to achieve a Type II anodic oxide thickness of about 13 μm. The samples were then again rinsed using water at ambient temperature.

The samples were then treated with Applicant's triple seal process described hereinabove. The first seal comprised a nickel acetate seal at about 185° F. for about 10 minutes followed by a deionized water rinse. The second seal comprised a sodium dichromate seal at about 200° F. for about 15 minutes followed by a deionized water rinse. The third seal comprised a hot water seal at about 200° F. for about 15 minutes.

The samples were then cryogenically processed using the method 400 depicted in FIG. 4 with a 6 hour ramp down time from ambient temperature to the target temperature of −320° F., a 12 hour hold time at the target temperature, and a 6 hour ramp up time to ambient temperature.

Both groups were tested for corrosion, the ability of the anodic coating to withstand flexing, and for impact resistance. At least one panel was subjected to each of a 45° degree bend, a 135° bend, and a 180° bend and subsequently exposed to a salt spray chamber, as described above, for a period of 336 hours. All tested samples satisfied the 336 hour salt spray exposure test in compliance with MIL-A-8625 specification requirements for corrosion resistance.

Samples were also subjected to impact testing. The anodic layer remained intact, as inspected at 10× magnification, for impact forces of up to 100 pounds.

Test Sample #2—6061 Aluminum, Type III, Class 1 Anodic Layer

Samples of 6061 aluminum were anodized to form a Type III, Class 1 anodic coating. The samples were first cleaned in an alkaline soap bath at about 150° F. for about five minutes. The samples were then rinsed using water at ambient temperature. The samples were then deoxidized in an acidic solution at a temperature of about 75° F. for about five minutes. The samples were then again rinsed using water at ambient temperature. The samples were then etched in a solution at about 110° F. for about 15 minutes. In one embodiment, the etching solution is a caustic solution of sodium hydroxide formed by mixing 120 lbs of sodium hydroxide in 300 gallons of water. The samples were then again rinsed using water at ambient temperature. The samples were then deoxidized in an acidic solution at a temperature of about 75° F. for about five minutes. The samples were then again rinsed using water at ambient temperature.

The samples were then immersed in an anodizing bath comprising sulfuric acid at about 35° F. An anodization layer was deposited on the sample using a process voltage of about 42 volts for about 60 minutes to achieve a Type III anodic oxide thickness of about 46 μm. The samples were then again rinsed using water at ambient temperature.

The samples were then treated with a triple seal process. The first seal comprised a nickel acetate seal at about 185° F. for about 10 minutes followed by a deionized water rinse. The second seal comprised a sodium dichromate seal at about 200° F. for about 15 minutes followed by a deionized water rinse. The third seal comprised a hot water seal at about 200° F. for about 15 minutes.

The samples were then cryogenically processed using the method 400 depicted in FIG. 4 with a 6 hour ramp down time from ambient temperature to the target temperature of −320° F., a 12 hour hold time at the target temperature, and a 6 hour ramp up time to ambient temperature.

Samples were tested for corrosion, the ability of the anodic coating to withstand flexing, and for impact resistance. At least one panel was subjected to a 45° degree bend, a 135° bend, and a 180° bend and subsequently exposed to a salt spray chamber, as described above, for a period of 336 hours. The samples showed no visible signs of corrosion on any exposed surface and therefore conformed with MIL-A-8625 specification requirements for corrosion resistance. In addition, the anodic layer remained intact even in the bent areas, showing that Applicant's anodic layer is able to flex without losing its protective properties.

Samples were also tested for extended corrosion resistance. These samples were exposed to a continuous salt spray (as described above) for 2,904 hours (nearly 121 days or nearly 4 months), which is nearly 9 times the MIL-A-8625 specification requirement of 336 hours. The surface of the samples exhibited absolutely no visible signs of corrosion on any exposed surface.

Samples were also tested for extended abrasion resistance. These samples were exposed to 51,000 cycles using the abrasion procedure described above. On inspection, the oxide layer was able to withstand the extended testing and prevented the abrasion wheels from breaking though the anodic oxide layer to expose the substrate. The samples displayed the first signs of breakthrough at 56,000 cycles and full wear of the oxide layer at 56,200 cycles.

Test Sample #3—6061, 2024 Aluminum, Chemical Conversion Coating

Samples of 6061 and 2024 aluminum were treated to form a chemical conversion coating. The samples were first cleaned in an alkaline soap bath at about 150° F. for about five minutes. The samples were then rinsed using water at ambient temperature. The samples were then etched in a solution at about 110° F. for about 15 minutes. In one embodiment, the etching solution is a caustic solution of sodium hydroxide formed by mixing 120 lbs of sodium hydroxide in 300 gallons of water. The samples were then again rinsed using water at ambient temperature. The samples were then deoxidized in an acidic solution at a temperature of about 75° F. for about five minutes. The samples were then again rinsed using water at ambient temperature.

Samples were then immersed in a chemical conversion solution comprising hexavalent chromium or trivalent chromium at about 80° F. for about 3 minutes and subsequently rinsed with deionized water having a resistivity of <10 megohms/cm. The hexavalent chromium used for the present testing is sold in commerce as Alodine 1600 by Henkel Corp. The trivalent chromium used for the present testing is sold in commerce as Alodine T5900 and Alodine T5900 Toner by Henkel Corp. Other brands of hexavalent and trivalent chromium may also be used.

The samples were then cryogenically processed using the method 400 depicted in FIG. 4 with a 6 hour ramp down time from ambient temperature to the target temperature of −380° F., 1 12 hour hold time at the target temperature, and a 6 hour ramp up time to ambient temperature.

The samples were subjected to salt spray testing as described above for 312 hours. Both the 6061 and 2024 aluminum samples conformed with the 168 hour salt spray requirement of MIL-C-5541 military specification for corrosion resistance.

Test Sample #4—6061 Aluminum, Type III, Class 1 Anodic Layer

Samples of 6061 aluminum were anodized to form a Type III, Class 1 anodic coating. The samples were first cleaned in an alkaline soap bath at about 150° F. for about five minutes. The samples were then rinsed using water at ambient temperature. The samples were then deoxidized in an acidic solution at a temperature of about 75° F. for about five minutes. The samples were then again rinsed using water at ambient temperature. The samples were then etched in a solution at about 110° F. for about 15 minutes. In one embodiment, the etching solution is a caustic solution of sodium hydroxide formed by mixing 120 lbs of sodium hydroxide in 300 gallons of water. The samples were then again rinsed using water at ambient temperature. The samples were then deoxidized in an acidic solution at a temperature of about 75° F. for about five minutes. The samples were then again rinsed using water at ambient temperature.

The samples were then immersed in an anodizing bath comprising sulfuric acid at about 35° F. An anodization layer was deposited on the sample to achieve a Type III anodic oxide thickness of about 20 μm. The samples were then again rinsed using water at ambient temperature.

The samples were then treated with a triple seal process. The first seal comprised a nickel acetate seal at about 185° F. for about 10 minutes followed by a deionized water rinse. The second seal comprised a sodium dichromate seal at about 200° F. for about 15 minutes followed by a deionized water rinse. The third seal comprised a hot water seal at about 200° F. for about 15 minutes.

The samples were then cryogenically processed using the method 400 depicted in FIG. 4 with a 6 hour ramp down time from ambient temperature to the target temperature of −320° F., a 12 hour hold time at the target temperature, and a 6 hour ramp up time to ambient temperature.

The samples were weighed before being immersed in a 7% solution of boric acid at about 89° F. for a period of up to 35 days. The samples were rinsed and weighed after being removed from the solution. The weight loss of each sample was calculated based off the starting weight as an indication of the loss of the anodic layer by exposure to the boric acid. The maximum decrease in panel weight observed was 0.0016 grams, indicating that a 7% solution of boric acid has minimal effect on Applicant's coating.

### Test Sample Result Summary

Applicant's coating and treating process results in aluminum coatings that are extremely corrosion resistant and impact resistant, and that are able to maintain these properties when flexed. The 6061, Type III, Class 1 samples with a triple sealed anodic coating that were subjected to cryogenic processing were able to exceed the MIL-A-8625 military specification salt spray test duration by nearly 900% without any visible signs of corrosion. Exposure to a concentrated (7%) solution of boric acid had no effect on the coating formed by Applicant's process. In addition, impact testing showed no visible cracking or delamination of the anodic layer. In fact, the anodic layer remained intact even after, in one test, the striking rod broke through the surface of the test sample itself. Finally, abrasion testing, even after 51,000 cycles, had virtually no effect on the integrity of the coating formed by Applicant's process.

The samples treated with a chemical conversion coating that were subjected to cryogenic processing were able to satisfy MIL-DTL-5541 military specification requirement for corrosion resistance. In addition, the 6061, Type III, Class 1 samples with a triple sealed anodic coating that were subjected to cryogenic processing were able to satisfy the MIL-A-8625 military specification requirement for corrosion resistance.

### Uses of Applicant's Coating Process

In one embodiment, Applicant's coating process is applied to articles to be used in acid or highly corrosive environments. In one embodiment, Applicant's coating process is applied to articles used in automotive or aeronautical applications, such as to coat mechanical parts or to coat the external body components of passenger or commercial vehicles. In one embodiment, Applicant's coating process is applied to wire used in transformers. In one embodiment, sheets of metal treated with Applicant's coating process are stacked to form a laminate that is capable of resisting bullets or other projectiles.

While the invention is described through the above-described exemplary embodiments, it will be understood by those of ordinary skill in the art that modifications to, and variations of, the illustrated embodiments may be made without departing from the inventive concepts disclosed herein. For example, although some aspects of making and using Applicant's coating has been described with reference to a series of steps, those skilled in the art should readily appreciate that functions, operations, decisions, etc., of all or a portion of each step, or a combination of steps, of the series of steps may be combined, separated into separate operations or performed in other orders. Moreover, while the embodiments are described in connection with various illustrative embodiments, one skilled in the art will recognize that the coating can be embodied using a variety of steps. Furthermore, disclosed aspects, or portions of these aspects, may be combined in ways not listed above. Accordingly, the invention should not be viewed as being limited to the disclosed embodiment(s).

The present invention may be embodied in other specific forms without departing from its spirit or essential characteristics. The described implementations are to be considered in all respects only as illustrative and not restrictive. The scope of the invention should, therefore, be determined not with reference to the above description, but instead should be determined with reference to the pending claims along with their full scope or equivalents, and all changes which come within the meaning and range of equivalency of the claims are to be embraced within their full scope.

What is claimed is:

1. A method to treat a surface of a metal substrate, comprising the following steps in the following order:
providing a metal substrate having an oxide layer;
treating said oxide layer; and
cooling said metal substrate to a temperature of −300° F. or less.

2. The method of claim 1, wherein said metal substrate is selected from the group consisting of aluminum, magnesium, steel, copper, iron, titanium, and alloys thereof.

3. The method of claim 1, wherein:
said metal substrate comprises aluminum; and
said oxide layer is formed by anodizing said aluminum.

4. The method of claim 3, wherein said aluminum is selected from the group consisting of 6061 aluminum alloy and 2024 aluminum alloy.

5. The method of claim 4, wherein said oxide layer is selected from the group consisting of Type II and Type III.

6. The method of claim 5, wherein said oxide layer is selected from the group consisting of Class 1 and Class 2.

7. The method of claim 1, wherein said treating comprises the following steps in the following order:
applying a composition comprising nickel to the oxide layer to form a first modified oxide layer;
applying a composition comprising chromium to the first modified oxide layer to form a second modified oxide layer; and
applying deionized water to the second modified oxide layer to form a third modified oxide layer.

8. The method of claim 7, wherein said metal substrate is cooled to a temperature of about −380° F.

9. The method of claim 7, wherein said metal substrate is cooled to a temperature below −400° F.

10. The method of claim 1, wherein said cooling comprises:
disposing said metal substrate is a cooling medium; and
lowering a temperature of said cooling medium at a rate of about 50° F. per hour.

11. The method of claim 10, further comprising maintaining said temperature of said cooling medium for about 10 hours to about 12 hours.

12. The method of claim 11, further comprising after said maintaining increasing the temperature of said cooling medium at a rate of about 50° F. per hour.

13. The method of claim 1, further comprising disposing a non-oxide coating on said metal substrate.

14. The method of claim 13, wherein said non-oxide coating is a powder coating.

15. A method to treat a surface of a metal substrate, comprising:
providing a metal substrate having a surface;
forming a non-oxide coating on said surface; and
cooling said metal substrate to a temperature of −300° F. or less.

16. The method of claim 15, wherein said metal comprises aluminum.

17. The method of claim 16, wherein said aluminum is selected from the group consisting of 6061 aluminum alloy and 2024 aluminum alloy.

18. The method of claim 15, wherein said non-oxide coating is a chemical conversion coating.

19. The method of claim 18, wherein said forming comprises immersing said metal substrate in a solution comprising hexavalent chromium.

20. The method of claim 18, wherein said forming comprises immersing said metal substrate in a solution comprising trivalent chromium.

21. The method of claim 18, wherein said metal substrate is cooled to a temperature of about −380° F.

22. The method of claim 18, wherein said metal substrate is cooled to a temperature below −400° F.

23. The method of claim 15, wherein said cooling comprises:
disposing said metal substrate is a cooling medium; and
lowering the temperature of said cooling medium at a rate of about 50° F. per hour.

24. The method of claim 23, further comprising maintaining said temperature of said cooling medium for about 10 hours to about 12 hours.

25. The method of claim 24, further comprising after said maintaining increasing the temperature of said cooling medium at a rate of about 50° F. per hour.

26. A metallic article of manufacture, formed by the process comprising the following steps in the following order:
providing a metal substrate having an oxide layer;
treating said oxide layer; and
cooling said metal substrate to a temperature of −300° F. or less.

27. The metallic article of manufacture of claim 26, wherein said metal substrate is selected from the group consisting of aluminum, magnesium, steel, copper, iron, and titanium, and alloys thereof.

28. The metallic article of manufacture of claim 27, wherein:
said metal substrate comprises aluminum; and
said oxide layer is formed by anodizing said aluminum.

29. The metallic article of manufacture of claim 28, wherein said aluminum is selected from the group consisting of 6061 aluminum alloy and 2024 aluminum alloy.

30. The method of claim 28, wherein said oxide coating is selected from the group consisting of Type II and Type III.

31. The method of claim 30, wherein said oxide coating is selected from the group consisting of Class 1 and Class 2.

32. The method of claim 26, wherein said treating comprises the following steps in the following order:
applying a composition comprising nickel to the oxide layer to form a first modified oxide layer;
applying a composition comprising chromium to the first modified oxide layer to form a second modified oxide layer; and
applying deionized water to the second modified oxide layer to form a third modified oxide layer.

33. The method of claim 32, wherein said metal substrate is cooled to a temperature of about −380° F.

34. The method of claim 32, wherein said metal substrate is cooled to a temperature below −400° F.

35. The method of claim 32, wherein said cooling comprises:
disposing said metal substrate is a cooling medium; and
lowering the temperature of said cooling medium at a rate of about 50° F. per hour.

36. The method of claim 35, further comprising maintaining said temperature of said cooling medium for about 10 hours to about 12 hours.

37. The method of claim 36, further comprising after said maintaining increasing the temperature of said cooling medium at a rate of about 50° F. per hour.

38. The method of claim 26, further comprising disposing a non-oxide coating on said metal substrate.

39. The method of claim 38, wherein said non-oxide coating is a powder coating.
